(19) United States
(12) Patent Application Publication
(10) Pub. No.: US 2012/0223810 A1
(43) Pub. Date: Sep. 6, 2012

(54) SYSTEM AND METHOD FOR EXTENDING REMOTE VEHICLE CONTROL FUNCTIONS

(75) Inventors: David R. Petrucci, Warren, MI (US); Gregg R. Kittinger, Pontiac, MI (US); Donald B. Hibbard, JR., Howell, MI (US); Ron Yousif Asmar, Southfield, MI (US); Mark A. Wisnewski, Stockbridge, MI (US)

(73) Assignee: GM GLOBAL TECHNOLOGY OPERATIONS LLC, Detroit, MI (US)

(21) Appl. No.: 13/040,698

(22) Filed: Mar. 4, 2011

(51) Int. Cl. G06F 7/04

(52) U.S. Cl. 340/5.64

(57) ABSTRACT

A remote keyless system (RKS) includes a remote control device configured to create a signal having at least a component at a first frequency and an antenna assembly coupled to a vehicle that includes a first antenna tuned to receive a signal in a frequency band. The RKS also includes a first filter coupled to the first antenna and configured to pass the first frequency and a second filter coupled to the first antenna and configured to pass the frequency band. The RKS also includes a remote keyless system controller coupled to the first filter that, upon receipt of a predetermined signal, causes the vehicle to perform an action. The first frequency is an integer multiple of a frequency in the frequency band.

### FIELD OF THE INVENTION

The subject invention relates to vehicles and, more particularly, to controlling aspects of a vehicle from a remote location.

### BACKGROUND

Remote keyless systems (RKS) are designed to control the operation of aspects of a vehicle or other machine based on a signal received from a remote control device. Some remote keyless entry systems include both a remote keyless entry system (RKE) and a remote keyless ignition system (RKI).

An RKE allows access to a vehicle based on one or more signals received from a remote control device. In some cases, the remote control device is integrated in to a unit that also includes the key to the vehicle. Regardless of how implemented, the remote control device can be utilized to lock or unlock power door locks without physical contact and from a distance away from the vehicle. Similarly, an RKI allows the vehicle to be started without physical contact with the vehicle.

RKE's and RKI's are becoming more common in automobiles as either an initial feature or as an after market add-on. Historically, RKS's employed a stand alone or dedicated antenna structure in either the front windshield or in the back glass to receive signals from the remote control device. The standalone antenna is typically mounted on or near the front windshield and can cause interference with other systems located near it. In some cases, the antenna can be located on the back glass but this increases cost and also can degrade the FM antenna performance due to capacitive coupling between the FM antenna and the RKS antenna as well as detuning the FM antenna.

Accordingly, it is desirable to provide a way to provide an RKS that avoids or reduces one or more of the drawbacks described above.

### SUMMARY OF THE INVENTION

In one exemplary embodiment of the present invention, a remote keyless system is disclosed. The remote keyless system of this embodiment includes a remote control device configured to create a signal having at least a component at a first frequency and an antenna assembly coupled to a vehicle, the antenna assembly including a first antenna tuned to receive a signal in a frequency band. The remote keyless system of this embodiment also includes a first filter coupled to the first antenna and configured to pass the first frequency, a second filter coupled to the first antenna and configured to pass the frequency band and a remote keyless system controller coupled to the first filter that, upon receipt of a predetermined signal, causes the vehicle to perform an action. In this embodiment, the first frequency is an integer multiple of a frequency in the frequency band.

In another exemplary embodiment of the present invention, a vehicle that includes remote keyless system controller configured to receive a signal having a first frequency and to cause the vehicle to perform an action is disclosed. The vehicle of this embodiment also includes an antenna assembly coupled to the vehicle tuned to receive a signal in a frequency band and a first filter coupled to the first antenna and configured to pass the first frequency. The vehicle also includes a second filter coupled to the first antenna and configured to pass the frequency band. The first frequency is an integer multiple of a frequency in the frequency band.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 illustrates an RKS system according to an exemplary embodiment;

FIG. 2 illustrates a back glass of vehicle including an RKS system according to an embodiment of the present invention; and

FIG. 3 is block diagram of a circuit that may be employed by embodiments of the present invention.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In accordance with an exemplary embodiment of the invention a system for remote control of either or both an RKE or an RKI (collectively or individually referred to herein as an RKS) for a vehicle is disclosed. The system does not require an additional antenna structure beyond the FM antenna structure utilized by the vehicle to receive FM radio. In one embodiment, the RKS transmits information from a remote control device to the vehicle on a carrier signal having a frequency of or about 315 MHz. In a particular embodiment, the remote control transmits data on a carrier signal having a frequency of 314.9 MHz The carrier frequency is detectable by the FM antenna of the typical vehicle as it represents the third harmonic of a 105 MHz signal. A 105 MHz signal falls within the FM radio frequency band of 87.5 to 108.0 MHz. Of course, remote control devices that operate at other than about 315 MHz are within the scope of the invention as long as the signal is a harmonic of a signal in the FM band.

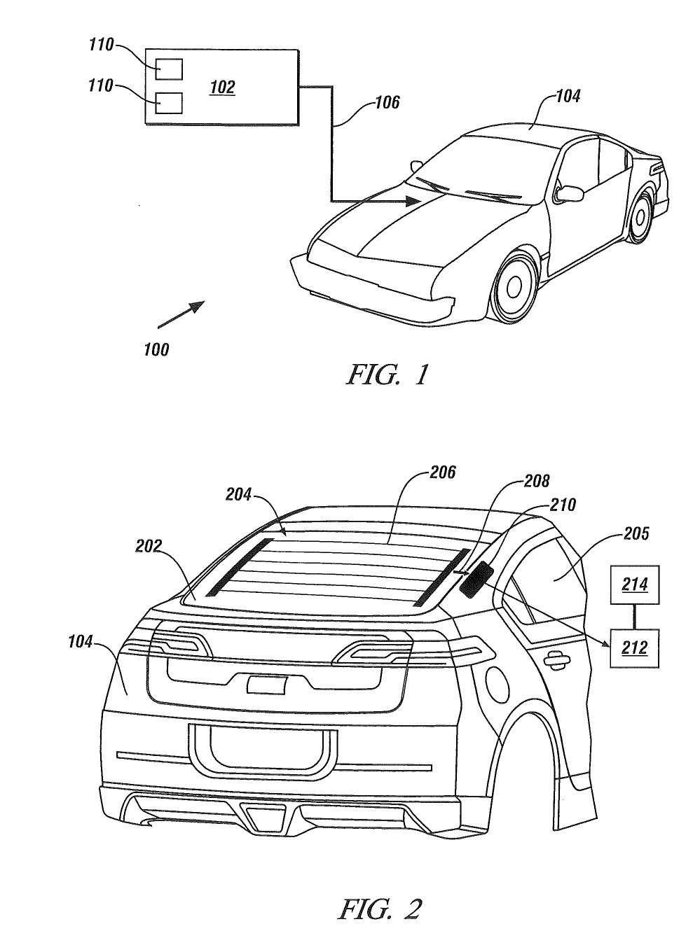

Turning now to FIG. 1, an RKS system 100 in accordance with an exemplary embodiment will now be described. The system 100 includes a remote control device 102 in communication with a vehicle 104 over a wireless connection 106.

The remote control device 102 can take many forms and needs only to broadcast a signal that may ultimately be received by the vehicle 104. In one embodiment, the remote control device 102 can be a transmitter that includes one or more buttons 110 that, when activated, cause it to transmit a signal over the wireless connection 106 (e.g., air). The signals are received by the vehicle 104 and cause it perform certain actions. For example, the signals can cause the engine of the vehicle 104 to start, the doors to lock or unlock, the trunk to open, an alarm to be activated or deactivated, windows of the vehicle to open or close, the horn to sound, or any other function. According to one embodiment, the signals are transmitted as radio waves at or about 315 MHz. In another embodiment, the signals are transmitted at any frequency that is an integer multiple of any frequency in the range between 87.5 and 108.0 MHz. For example, the signals transmitted by the remote control device 102 could be the second, third, fourth, etc, harmonic of any signal in the range between 87.5 and 108.0 MHz.

FIG. 2 illustrates a back glass 202 of a vehicle 104 according to one embodiment. The back glass 202 includes an antenna assembly 204 disposed within or on it as is standard in the industry. It shall be understood that while the antenna assembly 204 is illustrated in the back glass 202 it could be located in any other suitable location. For example, the antenna assembly 204 could be located in a side window 205.

In one embodiment, the antenna assembly 204 can receive either or both AM and FM radio waves. In one embodiment, the antenna assembly 204 is tuned to receive FM radio waves in the FM radio band of about 87.5 to 108.0 MHz. In one embodiment, the antenna assembly can provide heat to the back glass 202 to defrost it. As illustrated, the antenna assembly 204 includes a plurality of traces 206 that collectively, form the assembly. The traces 206 are formed of metal or another suitable material for receiving radio waves.

The antenna assembly 204 is coupled via connection 208 to an amplifier 210. The connection 208 is a pig tail connection in one embodiment. One output of the amplifier 210 is coupled to an RKS receiver module 212 that decodes the signal received by the antenna assembly 204 (and possibly amplified or otherwise adjusted by the amplifier 210) from the remote control device 102 (FIG. 1). The decoded signal is then provided to a control module 214 that causes the desired function to be performed. It shall be appreciated that the RKS receiver module 212 can be integrated into the amplifier 210 in one embodiment. Further, it may be beneficial to locate the amplifier 210 close to the antenna assembly 204 to reduce/minimize the length of the connection 208 and thereby reducing any length based signal attenuation the connection 208 may cause. Of course, the location of the RKS receiver module 212 and the control module 214 could be located in any location in the vehicle 104.

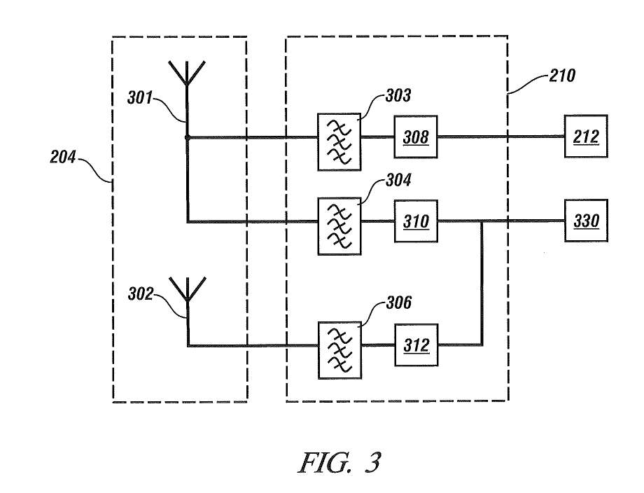

FIG. 3 is a circuit diagram of the active elements shown in FIG. 2. In particular, FIG. 3 illustrates the antenna assembly 204 coupled to the amplifier 210. The amplifier 210 is illustrated as being coupled to both an RKE receiver module 212 and to a radio receiver 330. It shall be understood that either or both of the RKE receiver module 212 and the radio receiver 330 could be wholly or partially included in the amplifier 210.

The antenna assembly 204 may include both an FM antenna 301 and an AM antenna 302. The antenna assembly 204 can be formed in many different manners as is known in the art. The FM antenna 301 is coupled to two filters 303, 304. The first filter 303 is tuned to pass frequencies surrounding the frequency at which the remote control device 102 (FIG. 1) transmits. The second filter 304 is tuned to pass frequencies in the FM radio band. A third filter 306 is also included and is coupled to the AM antenna 302. Of course, neither the AM antenna 302 nor the third filter 306 are required.

The second filter 304 is coupled to an FM amplifier 310 and the third filter is coupled to an AM amplifier 312. The outputs of these two amplifiers 310, 312 are provided to the radio receiver 330. Of course, other elements could be provided between the amplifiers 310, 312 to isolate the signals from one another or they could be separately coupled to the radio receiver 330.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the present application.

What is claimed is:

1. A remote keyless system comprising:
a remote control device configured to create a signal having at least a component at a first frequency;
an antenna assembly coupled to a vehicle, the antenna assembly including a first antenna tuned to receive a signal in a frequency band;
a first filter coupled to the first antenna and configured to pass the first frequency;
a second filter coupled to the first antenna and configured to pass the frequency band; and
a remote keyless system controller coupled to the first filter that, upon receipt of a predetermined signal, causes the vehicle to perform an action;
wherein the first frequency is an integer multiple of a frequency in the frequency band.

2. The remote keyless system of claim 1, wherein the first frequency is about 315 MHz.

3. The remote keyless system of claim 2, wherein the first frequency is 314.9 MHz.

4. The remote keyless system of claim 1, wherein the frequency band includes frequencies between 87.5 to 108.0 MHz.

5. The remote keyless system of claim 1, wherein the first frequency is a third harmonic of one of the frequencies in the frequency band.

6. The remote keyless system of claim 1, further comprising:
a remote keyless system amplifier coupled between the first filter and the remote keyless system controller.

7. The remote keyless system of claim 1, wherein the first antenna is tuned to receive signals in an FM radio frequency band.

8. The remote keyless system of claim 7, further comprising a second antenna tuned to receive signals in an AM radio frequency band.

9. The remote keyless system of claim 8, wherein at least one of the first and second antennas are coupled to a back glass of the vehicle.

10. The remote keyless system of claim 1, wherein the action is selected from one of locking a door of the vehicle, unlocking a door of the vehicle, starting the vehicle or a combination thereof.

11. A vehicle comprising:
remote keyless system controller configured to receive a signal having a first frequency and to cause the vehicle to perform an action;
an antenna assembly coupled to the vehicle, the antenna assembly including a first antenna tuned to receive a signal in a frequency band;
a first filter coupled to the first antenna and configured to pass the first frequency; and
a second filter coupled to the first antenna and configured to pass the frequency band, wherein the first frequency is an integer multiple of a frequency in the frequency band.

12. The vehicle of claim 11, wherein the first frequency is about 315 MHz.

13. The vehicle of claim 12, wherein the first frequency is 314.9 MHz.

14. The vehicle of claim 11, wherein the frequency band includes frequencies between 87.5 to 108.0 MHz.

15. The vehicle of claim 11, wherein the first frequency is a third harmonic of one of the frequencies in the frequency band.

16. The vehicle of claim 11, further comprising:
a remote keyless system amplifier coupled between the first filter and the remote keyless system controller.

17. The vehicle of claim 11, wherein the first antenna is tuned to receive signals in an FM radio frequency band.

18. The remote keyless system of claim 17, further comprising a second antenna tuned to receive signals in an AM radio frequency band.

19. The vehicle of claim 18, wherein at least one of the first and second antennas are coupled to a back glass of the vehicle.

20. The remote keyless system of claim 11, wherein the action is selected from one of locking a door of the vehicle, unlocking a door of the vehicle, starting the vehicle or a combination thereof.
